(19) United States
(12) Patent Application Publication
(10) Pub. No.: US 2006/0274707 A1
(43) Pub. Date: Dec. 7, 2006

(54) Ultra wide band radio frequency sending method and device

(76) Inventors: Stanislas Voinot, Grenoble (FR); Emil Novakov, Meylan (FR)

Correspondence Address: CLARK & BRODY, 1090 VERMONT AVENUE, NW, SUITE 250, WASHINGTON, DC, 20005, US

(21) Appl. No.: 11/400,203

(22) Filed: Apr. 10, 2006

Related U.S. Application Data
(63) Continuation of application No. PCT/FR05/02677, filed on Oct. 20, 2005.
(60) Provisional application No. 60/669,359, filed on Apr. 8, 2005.

(30) Foreign Application Priority Data
Oct. 27, 2004 (FR) 0411459

(51) Int. Cl. H04J 1/00

(52) U.S. Cl. 370/342; 370/343; 375/140

(57) ABSTRACT

This device for sending binary data (cᵢ) at radio frequency in a transmission channel comprises:
a signal generator designed to generate, for each binary data item (cᵢ), a pulsed signal (pᵢ) of duration shorter than the duration of said binary data item (cᵢ);
means of multiplication of said pulsed signal (pᵢ) by at least one periodic signal of variable frequency (fⱼ) specific to said sending device, said variable frequency (fⱼ) being greater than the frequency of said pulsed signal (pᵢ); and
means of sending the pulsed signal (pᵢ.fⱼ) resulting from said multiplication.

The present invention relates to the field of spread spectrum, ultra wide band (UWB) and frequency diversity pulsed radio frequency binary data transmission systems.

The invention relates more particularly to a device and method for sending and a device and a method for receiving such data.

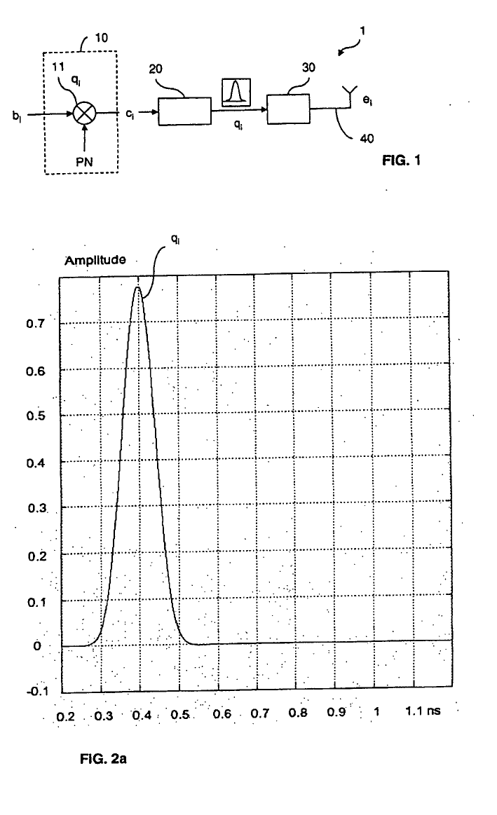

First to be described, with reference to FIGS. 1 to 3, will be a spread spectrum radio frequency sender and receiver which use an ultra wide band (UWB) pulsed transmission, these devices being known to those skilled in the art.

The conventional sender 1 for information data bᵢ, represented in FIG. 1, comprises spectral spreading means 10, of the direct sequence spread spectrum (DS-SS) type, for this information data bᵢ, with which to obtain binary data cᵢ.

In a known manner, the DS-SS spreading means 10 mainly comprise a multiplier 11 of the binary data bᵢ by a pseudo-random code PN.

The conventional sender 1 also comprises a pulsed signal generator 20 designed to supply a pulsed signal qᵢ from each binary data item cᵢ at the output of the spreading means 10.

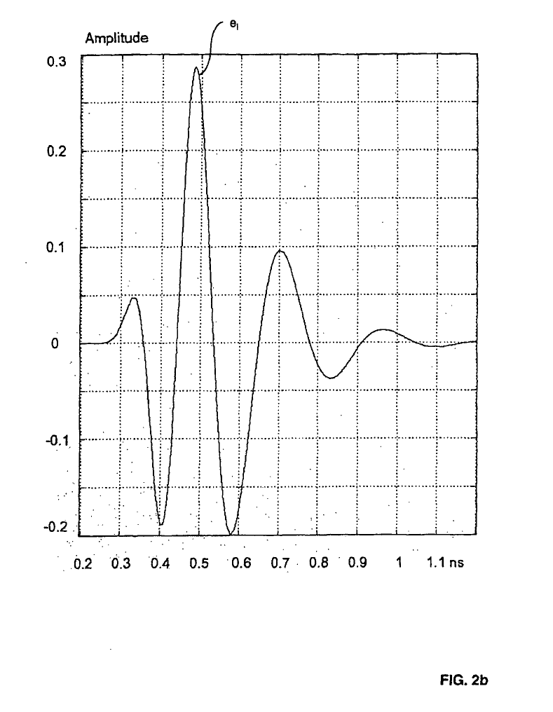

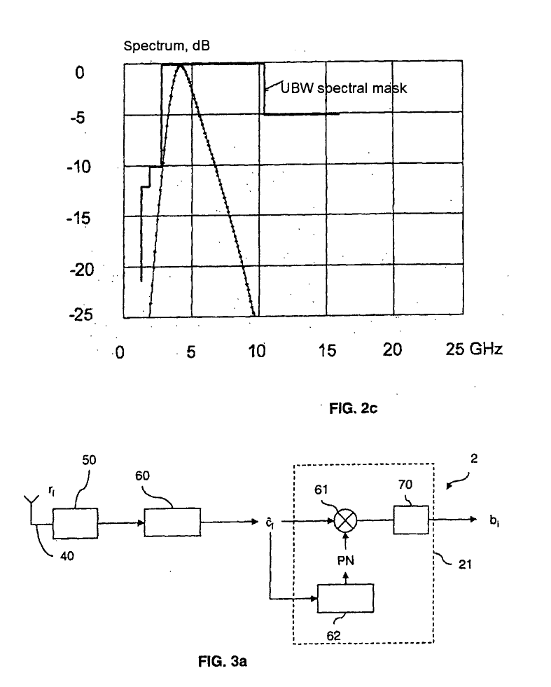

This pulsed signal qᵢ, of Gaussian form and duration approximately equal to 0.2 ns, is represented in FIG. 2a.

In a known manner, the conventional sender 1 also comprises a power amplifier 30 and an antenna 40 for sending the pulsed signals qᵢ in the transmission channel.

The sending antenna 40, which acts as a bandpass filter, shunts the amplified Gaussian signal qᵢ and sends an electromagnetic wave in the form of pulsed signals eᵢ.

FIG. 2b represents the form of the pulsed signals sent eᵢ in the case of a conventional ultra wide band (UWB) pulsed sender 1.

The spectrum of the signal sent eᵢ is represented in FIG. 2c.

The conventional sender of FIG. 1 is also used for CDMA multiple access techniques.

Those skilled in the art will understand that the spectrum of the signal sent ei is much greater than the spectrum of each binary data item or the binary data bᵢ, which characterizes in particular a spread spectrum device.

If the duration of a pulsed signal qᵢ is approximately 0.2 ns, and the antenna 40 is an antenna of bandwidth from 3 to 11 GHz, the spectrum of the signal sent by the antenna 40 and measured at −10 dB is 3.1 to 7 GHz. Thus, the signal sent eᵢ has a spectrum that falls within the frequency range [3.1, 10.6 GHz] reserved for UWB communications.

FIG. 2c also shows, in relative units, the form of the spectral mask allowed for UWB communications. By definition, a signal is considered to be ultra wide band (UWB) if the width of its spectrum at −10 dB is greater than 500 MHz. Since the width of the spectrum of the signal eᵢ is 3.9 GHz, this signal eᵢ sent by the antenna is of UWB type.

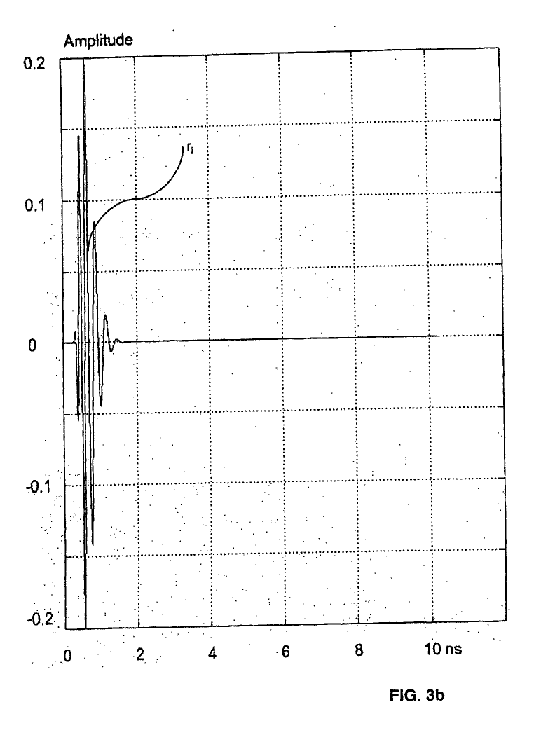

These signals sent eᵢ can be received by the conventional receiver 2 known to those skilled in the art and represented in FIG. 3a.

This conventional receiver comprises a receiving antenna 40 which also acts as a bandpass filter and shunts the signal sent eᵢ.

At the output of the receiving antenna 40, a received signal rᵢ is obtained, having the form indicated in FIG. 3b. The receiving antenna 40 of FIG. 3a has the same bandwidth as the sending antenna 40 of FIG. 1.

This conventional receiver 2 comprises a low noise amplifier 50 designed to deliver the signals received rᵢ and amplified to a pulsed signal detector 60.

In a manner known to those skilled in the art, the pulsed signal detector 60 mainly comprises a filter designed to detect the form of the signal received rᵢ, and to supply, as output, a signal ĉᵢ which is an estimator of the binary data item cᵢ supplied as input to the pulsed signal generator 20 of the conventional sender 1. It is also possible to implement the tuned filter 60 as a correlator.

The estimated signal ĉᵢ is supplied simultaneously as input to a synchronization unit 62 and a multiplier 61 similar to the multiplier 11 of the conventional sender 1.

In a manner known to those skilled in the art, the synchronization unit 62 is designed to generate, from the estimated signal ĉᵢ, the pseudo-random code PN identical to that supplied as input to the multiplier 11 of the conventional sender 1 for spreading the information data bᵢ.

The pseudo-random code PN is supplied as input to the multiplier 61 which generates, by multiplying the estimated signal ĉᵢ by the pseudo-random code PN, an intermediate signal supplied as input to an integrator 70.

In a known manner, this integrator 70 is used to obtain the information data item bᵢ.

Those skilled in the art will understand that the assembly formed by the synchronization unit 62, the multiplier 61 and the integrator 70 constitutes a DS-SS means 21 of unspreading of the estimated signal ĉᵢ.

Naturally, the synchronization block 62 knows the pseudo-random code PN used on sending, this code PN being generated on the receiver 2 synchronously with the code PN on sending.

The transmission system formed by the conventional sender 1 and receiver 2 described previously features two major drawbacks:

Firstly, the form of the spectrum of the signal sent eᵢ represented in FIG. 2b directly depends on the form of the Gaussian pulsed signal qᵢ of FIG. 2a. Of course, this drawback is all the more critical because the Gaussian pulse must be generated at frequencies measured in GHz where it is extremely difficult to control the form of the signals obtained.

In FIG. 2c, it can also be seen that the spectrum of eᵢ does not fully comply with the UWB spectral mask allowed, therefore sending cannot take place with the maximum permitted power and sending is not optimal.

Secondly, the detector 60 of the pulsed signal sent needs to know the form of the signal received rᵢ, this form being able in particular to vary according to the type and orientation of the sending and receiving antennas 40, and the physical characteristics of the transmission channel. In the case where the propagation channel between the sender and the receiver is of the type with fast fading (frequency selective), the form of the signal received rᵢ will be highly affected by the characteristics of the channel.

Furthermore, detection is all the more difficult because of the fact that it is performed on a very high frequency received pulse rᵢ.

The invention can be used to overcome these drawbacks.

To this end, and, according to a first aspect, the invention relates to a device for sending binary data at radio frequency in a transmission channel comprising a signal generator designed to generate, for each binary data item, a pulsed signal of duration shorter than the duration of said binary data item, means of multiplying this pulsed signal by at least one periodic signal of variable frequency specific to the sending device, this variable frequency being greater than the frequency that corresponds to the duration of the pulsed signal, and means of sending the pulsed signal resulting from this multiplication.

In the case of a UWB system, the duration of the pulsed signal used to obtain a frequency band of 500 MHz must be less than 4 ns or approximately twenty times longer than the Gaussian pulse duration of the conventional system of FIG. 2a.

The pulsed signal used in the invention is therefore much easier to generate than the high frequency Gaussian pulse of the conventional sender.

In addition, the pulsed signal according to the invention is multiplied by a periodic signal of variable frequency specific to the sending device, which means that, on average, all the spectrum can be occupied by having this frequency varied within the range from 3.1 to 10.6 GHz without it being necessary to accurately adjust the form of the pulsed signal of the sending device.

In other words, these periodic signals of variable frequencies can be used to provide spectral smoothing. It will also be noted that this variable signal does not in itself convey information, which distinguishes the sending device according to the invention from a conventional frequency hopping spread spectrum (FH-SS) device.

Advantageously, since the variable frequency used by the sending device is specific to the sender, the device for receiving the signal does not need to know the variable frequency used.

In a preferred embodiment, the pulsed signal is multiplied by a number of variable frequency signals.

The sending device then comprises means of summing the pulsed signals resulting from these multiplications, these sending means being designed to send the pulse signal obtained by this summing. In this case, the pulsed signal is transmitted over a number of frequency bands, so providing a frequency diversity. This frequency diversity is used to effectively overcome the problems of radio signal propagation in the case of frequency selective channels.

Preferably, the variable frequencies used are random, which improves the spectral smoothing.

Preferably, the binary data transmitted by the device according to the invention is obtained by spectral spreading of information data.

This characteristic advantageously enables, as in the case of a conventional spread spectrum method, the information data to be transmitted over the entire spectrum, and this in a manner difficult to detect, this data being seen as noise by a third party system not knowing the pseudo-random spreading code.

In a preferred embodiment of the invention, the time difference between two consecutive pulsed signals is greater than the depth of the delays of the multiple paths in the transmission channel.

Those skilled in the art will understand that this characteristic advantageously enables an equalizer to be dispensed with in the receiver.

Correlatively, the invention relates to a method of sending binary data at radio frequency in a transmission channel, this method comprising, for each binary data item:
a step for generating a pulsed signal of duration shorter than the duration of said binary data;
a step for multiplying this pulsed signal by at least one periodic signal of variable frequency specific to the sending method, this variable frequency being greater than the frequency that corresponds to the duration of the pulsed signal; and
a step for sending the signal resulting from this multiplication step.

Since the particular advantages of the sending method are the same as those of the sending device mentioned previously, they will not be reviewed here.

Other aspects and advantages of the present invention will become more clearly apparent from the description of particular embodiments that follows, this description being given purely as a nonlimiting example and with reference to the appended drawings in which:

FIG. 1, already described, diagrammatically represents a conventional sender of the state of the art;

FIG. 2a, already described, represents an intermediate pulsed signal of Gaussian form used by the sender of FIG. 1;

FIG. 2b, already described, represents the form of the pulsed signal sent by the antenna of the sender of FIG. 1;

FIG. 2c, already described, represents the frequency spectrum corresponding to the signal sent in FIG. 2b;

FIG. 3a, already described, represents a conventional receiver known from the state of the art;

FIG. 3b, already described, represents the form of a signal received at the output of the receiving antenna of the receiver of FIG. 3a;

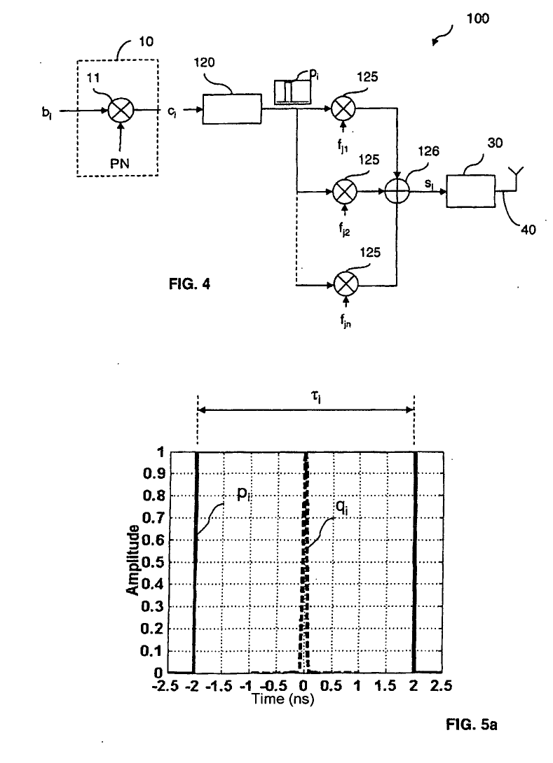

FIG. 4 represents a sending device in accordance with the invention in a preferred embodiment;

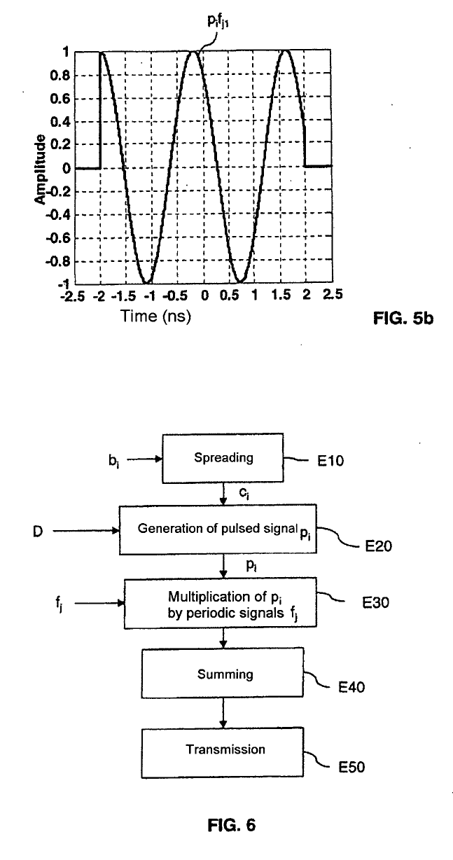

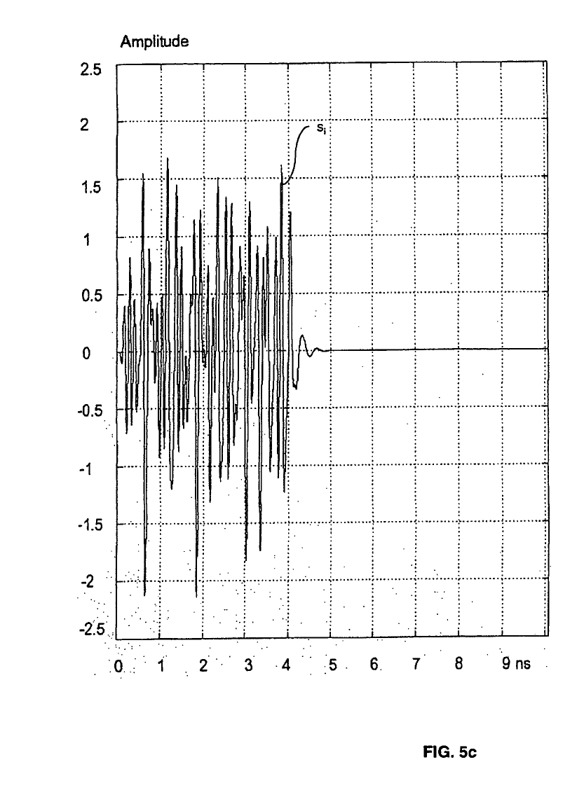

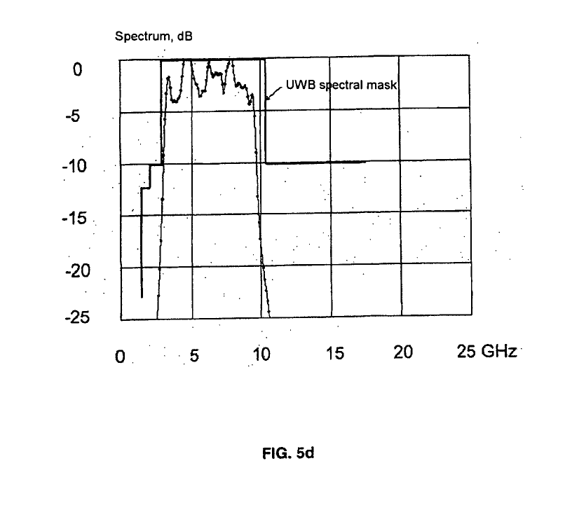

FIG. 5a represents the form of a pulsed signal used in the sending device of FIG. 4;

FIG. 5b represents the pulsed signal used in the sending device of FIG. 4 multiplied by a periodic signal used in the sending device of FIG. 4;

FIG. 5c represents the pulsed signal used in the sending device of FIG. 4 multiplied by several periodic signals of variable frequencies;

FIG. 5d represents the average frequency spectrum corresponding to a number of signals of the type of that of FIG. 5c ; and

FIG. 6 represents, in flow diagram form, the main steps of a sending method in accordance with the present invention.

FIG. 4 represents a device for sending information data bᵢ in accordance with the invention in a preferred embodiment.

The sender 100 comprises spreading means 10, identical or similar to those of the conventional sender 1 described previously with reference to FIG. 1.

These spreading means 10 are thus designed to generate binary data cᵢ by DS-SS spectral spreading of information data bᵢ.

The sending device 100 according to the invention comprises a pulse generator 120 designed to generate, for each binary data item cᵢ, a pulsed signal pᵢ of duration τᵢ such as that represented by a solid line in FIG. 5a.

In this same FIG. 5a, the Gaussian pulsed signal qᵢ, used in a conventional UWB sender and described previously with reference to FIG. 2a, is represented by a dashed line, for comparison purposes.

In the embodiment described here, it thus appears that the pulsed signal pᵢ of the invention is a square-wave signal of duration approximately twenty times greater than that of the Gaussian signal qᵢ of a conventional UWB system.

Those skilled in the art will easily understand that this pulsed signal pᵢ is much easier to generate and control than the pulsed signal qᵢ of the prior art.

In the preferred embodiment described here, the sending device 100 comprises a number of multipliers 125 designed to multiply the pulsed signal pᵢ by periodic signals of variable frequencies fⱼₗ, fⱼ₂ . . . fⱼₙ, these variable frequencies being specific to the sending device 100. The frequencies fⱼ are chosen to be greater than the frequency that corresponds to the duration τᵢ of the pulse pᵢ: fⱼ>1/τᵢ.

FIG. 5b represents the amplitude of the signal duly obtained at the output of the multiplier 125.

In this embodiment, the sending device 100 comprises means 126 of summing the signals output from the multipliers 125.

FIG. 5c represents the sum signal si obtained at the output of the summing means 126. This signal is obtained with four periodic signals of frequencies fⱼ.

The sending device 100 comprises a power amplifier 30 and an antenna 40 that are identical or similar to those of the conventional sender 1 described previously in FIG. 1, for sending, in the transmission channel, the signal sᵢ obtained at the output of the or each summing means 126.

FIG. 5d represents the average spectrum of the sum signal sᵢ corresponding to a pulsed signal qⱼ multiplied by four periodic signals of random variable frequencies fⱼ₁, fⱼ₂, fⱼ₃ and fⱼ₄.
Sᵢ=Σpᵢ.fⱼ=pᵢ*fⱼ₁+pᵢ*fⱼ₂+pᵢ*fⱼ₃+pᵢ*fⱼ₄

The frequencies fⱼ₁, fⱼ₂, fⱼ₃ and fⱼ₄ lie within the frequency band in which the spectrum of the signal sent sᵢ should be located. In the example described here, the frequencies fⱼ₁, fⱼ₂, fⱼ₃ and fⱼ₄ are located in the UWB band. Given that, for each pulsed signal pᵢ, the frequencies fⱼ vary, the spectrum of the sum signal sᵢ varies also.

In FIG. 5d representing the average spectrum of the signal sᵢ, it clearly appears that the spectrum of the sum signal sᵢ effectively occupies the entire spectral mask given for UWB communications.

Since for each pulsed signal pᵢ the frequencies fⱼ vary, the spectrum of the sum signal sᵢ also varies. FIG. 5d shows the average spectrum of the signal sᵢ. It can clearly be seen that the spectrum of the sum signal sᵢ effectively occupies the entire spectral mask given for UWB communications.

The sender 100 allows for a pulsed transmission over a frequency band that can be adjusted according to the frequencies fⱼ.

Those skilled in the art will understand that the invention facilitates the use of the legislated UWB band from 3.1 to 10.6 GHz and reception on the receiver 2.

In accordance with the invention, the variable frequencies used specific to the sending device do not convey any information. They are used simply for spreading the spectrum of the pulse pᵢ, and positioning the spectrum of the pulse pᵢ in the band defined by the legislation, to provide optimal occupancy of the spectrum and spectral smoothing.

Using the width of the pulse pᵢ, the number of variable frequencies fⱼ and the bands occupied when these frequencies vary, it is possible to accurately adjust the width of the spectrum of the sum signal sᵢ and the location of the spectrum of the sum signal sᵢ in the frequency domain and, in particular, on the band reserved for UWB communications.

Furthermore, the variable frequency hopping, generating a frequency diversity, minimizes the fading effects due to the propagation channel. It is well known that frequency diversity increases link reliability.

The filtering and derivation introduced by the receiving antenna do not affect the sum signal sᵢ. In practice, since the sum signal sᵢ is formed by a number of signals of variable frequencies sᵢ, their derivation is equivalent to a simple time offset.

In the preferred embodiment described here, the time difference D between two consecutive pulsed signals pᵢ, Pᵢ₊₁ is greater than the depth of the delays of the multiple paths in the transmission channel.

In practice, this time difference D is defined once for all on producing the device, according to the maximum time spread (or maximum depth of delays) of the usage environment provided between a sender and a receiver.

The signal sent by the sending device 100 according to the invention, can be received by a conventional receiver 2 as described previously for FIG. 4, provided that the pulse detector 60 is programmed to detect the envelope of the sum signal sᵢ.

FIG. 6 represents the main steps E10 to E50 of a method of sending an information data item according to the invention in a preferred embodiment.

This method comprises a first step E10 during which a DS-SS spectral spreading of the information data item bᵢ is performed to obtain a binary data item cᵢ.

This step consists, in a known manner, in multiplying the information data item bᵢ by a known pseudo-random code PN of the receive device 2.

The spreading step E10 is followed by a step E20 during which there is generated, for the binary data item cᵢ, a pulsed signal pᵢ, of duration τᵢ, this duration being shorter than the duration of the binary data item cᵢ.

In the preferred embodiment described here, the time difference between two consecutive pulsed signals pᵢ, Pᵢ₊₁ is greater than the maximum depth D of the delays of the multiple paths in the transmission channel.

The step E20 for generation of the pulsed signal pᵢ is followed by a step E30 during which the pulsed signal pᵢ is multiplied by a number of periodic signals of variable frequencies fⱼ: fⱼ₁, fⱼ₂ . . . fⱼₙ.

It will be remembered that there is no need for the frequencies fⱼ of these periodic signals to be known to the receiver 2.

In the preferred embodiment described here, the frequencies fⱼ of these periodic signals are chosen randomly.

This multiplication step E30 is followed by a step E40 during which the pulsed signals obtained during the preceding step E30 are summed, then by a step E50 during which the signal obtained during the preceding summing step E40 is sent in the transmission channel.

1. A device for sending binary data (cᵢ) at radio frequency in a transmission channel comprising:
a signal generator designed to generate, for each binary data item (cᵢ), a pulsed signal (pᵢ) of duration (τᵢ) shorter than the duration of said binary data item (cᵢ),
means for generating at least one periodic signal, the frequency (fⱼ) of which varies according to predetermined conditions, this variable frequency (fⱼ) being greater than a frequency (1/τᵢ) equal to the inverse of the duration (τᵢ) of said pulsed signal (pᵢ);
means of multiplying said pulsed signal (pᵢ) by said periodic signal of variable frequency (fⱼ); and
means of sending the pulsed signal (pᵢ.fⱼ) resulting from said multiplication.

2. The device as claimed in claim 1, wherein the variation of the frequency (fⱼ) of said periodic signal is such that the pulsed signal (pᵢ) resulting from said multiplication occupies approximately all the spectral width of the transmission channel.

3. The sending device as claimed in claim 1, which comprises means for generating independent periodic signals, the frequencies (fⱼ) of which vary according to predetermined conditions, these variable frequencies (fⱼ) being greater than a frequency (1/τᵢ) equal to the inverse of the duration (τᵢ) of said pulsed signal (pᵢ);
wherein said multiplication means are designed to multiply said pulsed signal (pᵢ) respectively by said signals of variable frequencies (fⱼ); and which comprises means of summing the pulsed signals (pᵢ.fⱼ) resulting from said multiplications;
said sending means being designed to send the pulsed signal (sᵢ=Σpᵢ.fⱼ) resulting from said summing.

4. The sending device as claimed in claim 1, wherein said variable frequency (fⱼ) is random.

5. The sending device as claimed in claim 1, wherein the frequency of said periodic signal of variable frequency varies during the multiplication of said pulsed signal (pᵢ).

6. The sending device as claimed in claim 1, wherein said binary data (c₁) is obtained by spectral spreading of information data (bᵢ).

7. The sending device as claimed in claim 1, wherein the time difference between two consecutive pulsed signals (pᵢ, pᵢ₊₁) is greater than the maximum depth of the delays of the multiple paths in said transmission channel.

8. A method of sending binary data (cᵢ) at radio frequency in a transmission channel, which consists, for each binary data item (cᵢ):
in generating a pulsed signal (pᵢ) of duration (τᵢ) shorter than the duration of said binary data (cᵢ);
in generating at least one periodic signal, the frequency (fⱼ) of which varies according to predetermined conditions, this variable frequency (fⱼ) being greater than a frequency (1/τᵢ) equal to the inverse of the duration (τᵢ) of said pulsed signal (pᵢ);
in multiplying said pulsed signal (pᵢ) by at least one periodic signal of variable frequency (fⱼ) specific to said sending method, said variable frequency (fⱼ) being greater than the frequency (1/τᵢ) of said pulsed signal (pᵢ); and
in sending said pulsed signal (pᵢ.fⱼ) resulting from said multiplication step.

9. The device as claimed in claim 8, wherein the pulsed signal (pᵢ) resulting from said multiplication occupies approximately all the spectral width of the transmission channel.

10. The sending method as claimed in claim 8, which consists
in generating independent periodic signals, the frequencies (fⱼ) of which vary according to predetermined conditions, these variable frequencies (fⱼ) being greater than a frequency (1/τᵢ) equal to the inverse of the duration (τᵢ) of said pulsed signal (pᵢ);
in multiplying said pulsed signal (pᵢ) by respectively said signals of variable frequencies (fⱼ); and consists:
in summing said pulsed signals (pᵢ.fⱼ) resulting from said multiplications; and
in sending the pulsed signal (sᵢ=Σpᵢ.fⱼ) resulting from said summing.

11. The sending method as claimed in claim 8, wherein, during said multiplication step, a periodic signal of random variable frequency (fⱼ) is used.

12. The sending method as claimed in claim 8, wherein the frequency (fⱼ) of the periodic signal of variable frequency is varied during the multiplication of said pulsed signal (pᵢ).

13. The sending method as claimed in claim 8, which includes a step for obtaining said binary data (cᵢ) by spectral spreading of information data (bᵢ).

14. The sending method as claimed in claim 8, wherein the time difference between two pulsed signal generation steps is greater than the maximum depth of the delays of the multiple paths in said transmission channel.
